(19) United States
(12) Patent Application Publication
(10) Pub. No.: US 2019/0337331 A1
(43) Pub. Date: Nov. 7, 2019

(54) Molded fiber wheel rim with outwardly-facing concave sidewalls

(71) Applicants: Raymond Anderson Scruggs, San Anselmo, CA (US); Emanis Russell, Keller, TX (US)

(72) Inventors: Raymond Anderson Scruggs, San Anselmo, CA (US); Emanis Russell, Keller, TX (US)

(21) Appl. No.: 15/972,195

(22) Filed: May 6, 2018

(51) Int. Cl. B60B 21/02; B60B 21/10

(52) U.S. Cl. CPC B60B 21/025; B60B 2900/311; B60B 2360/3416; B60B 21/10

(57) ABSTRACT

A molded fiber wheel rim that has good impact absorbing properties and increased durability. In one embodiment the wheel rim is comprised in molded fiber material such as carbon fiber having outwardly-facing concave sidewalls capable of improved durability while flexing in response to forces from rim compressing wheel load bearing inputs and wheel rolling surface impacts.

### BACKGROUND

A vehicle wheel rim retains a tire in place, and provides attachment points for spokes or other means of securing an axle hub. Many wheel rims are single wall, such as most automotive and other motor driven wheels, where rim weight is not high in priority. Motor driven wheels and rims are rarely made using molded fiber currently. Increased priorities for improvement in motor fuel consumption efficiencies have introduced some 100% molded fiber and hybrid aluminum and molded fiber wheel rim development for motor driven wheels. Some rims are hollow in design, such as the majority of currently available bicycle rims. A hollow rim has an advantage in greater stiffness for a given rim weight. The hollow rim is much like a tube of material, rolled or molded or fabricated otherwise into a round rim for a rolling wheel. Physically to form a wheel rim, a formed hollow tube of solid material shaped into a round rim is stiffer than a single wall rim, when each are the same circumference, width, weight, and material. A stiffer hollow rim can resist flex and support more weight loads with less deflection that a rim which is not hollow, such as, a single-wall rim of “U”, “I”, or “H” in cross section profile shape. For about 25 years bicycle rims using molded fibers, primarily carbon fiber, have been made for additional advantages of lower weight, improved flex deformation resistance, and improved durability, compared to rims made of aluminum or other materials.

Cross section profiles of existing molded fiber formed wheel rim sidewalls utilize variations of outside wall faces with straight or outward convex curving shapes.

While the wheeled vehicle is moving over the ground, each wheel tire and rim is loaded by the driver and vehicle framework and any vehicle additional loads. While each wheel is rolling on paved roads or off paved roads, in addition to tire deformation, there is rim side wall compression deformation or flex from the loaded weight. And a rolling wheel's rim wall is additionally flexed deeper in compression from any irregularity of the ground surface.

The problem with current designs of molded fiber straight rim wall or convex profile rim wall design, is extension of outside fibers or the outside layers of laminated fabric layers of molded fibers. Every fiber has limited extension stretch characteristics. When extended fibers can no longer stretch any longer, the fibers break, and reduce the overall strength and durability causing failure of a molded fiber rim wall to carry intended loads. There is always extension of outside fibers or fiber laminate layers when designed with outwardly-facing convex curved profile, when deformed by the compression from wheel radial loads, carried weight loads and impact loads. Straight wall rim profile when compression flexed from load, produce irregular extension of outside fibers or fiber laminate layers, when deformed by the compression from wheel radial loads, carried weight loads and impact loads.

### BRIEF SUMMARY OF THE INVENTION

Molded fiber formed wheel rim walls including an outwardly-facing concave shape when viewed in cross section profile.

All fibers or laminated layers of fibers of a outwardly-facing concave shaped molded fiber rim wall are compressed when deformed from vehicle carried weight loads and impact loads. The compression of all fibers or laminated layers of fibers eliminates the problem of excessive extending fiber stretch to breakage, when a wheel rim is deformed vertically by radial wheel loads, from carried weight loads and impact loads.

### BRIEF DESCRIPTION OF THE DRAWINGS

The accompanying drawings or diagrams illustrate the areas of specification and various examples of execution of the descriptions herein. The illustrated examples are merely examples and do not limit the scope of the claims.

FIG. 1 to FIG. 8 are diagrams of prior art. FIGS. 1, 2, and 3 are an existing art illustrative example of a single wall wheel rim.

FIGS. 4, 5, 6, and 7 are various views of an existing art illustrative example of convex shaped walls of hollow bicycle wheel rim.

FIG. 8 is an illustrative example of straight shaped walls of hollow bicycle wheel rim profile.

FIG. 9 is an illustrative example of a single wall wheel rim having outward-facing concave sidewalls.

FIG. 10 is an illustrative example of a hollow rim, often called a “double-wall” wheel rim in bicycle terminology, having relatively short depth outward-facing concave sidewalls.

FIG. 11 is an illustrative example of a hollow rim, often called a “double-wall” wheel rim in bicycle terminology, having relatively deep outward-facing concave sidewalls.

FIG. 12 is an illustrative example of a hollow rim, often called a “double-wall” wheel rim in bicycle terminology, having relatively short depth outward-facing concave sidewalls, and asymmetrical spoke attachment.

FIG. 13 is an illustrative example of a hollow rim, often called a “double-wall” wheel rim in bicycle terminology, having relatively deep outward-facing concave sidewalls transitioning into outwardly-facing convex sidewalls.

FIG. 14 is an illustrative example of a straight shaped rim wall of a hollow bicycle wheel rim profile, constructed with molded fiber, both unloaded and the effect to this rim wall shape when flexed by load.

FIG. 15 is an illustrative example of a rim wall having outward-facing convex sidewalls of a hollow bicycle wheel rim profile, constructed with molded fiber, both unloaded and the effect to this rim wall shape when flexed by load.

FIG. 16 is an illustrative example of a rim wall having outward-facing concave sidewalls of a hollow bicycle wheel rim profile, constructed with molded fiber, both unloaded and the effect to this rim wall shape when flexed by load.

### DETAILED DESCRIPTION

As noted above, a wheel rim retains a tire in place, and provide attachment points for spokes or other means of securing an axle hub. Some rims are hollow in design, such as the majority of currently available bicycle rims. A hollow rim has an advantage in stiffness and deformation or flex resistance for a given rim weight.

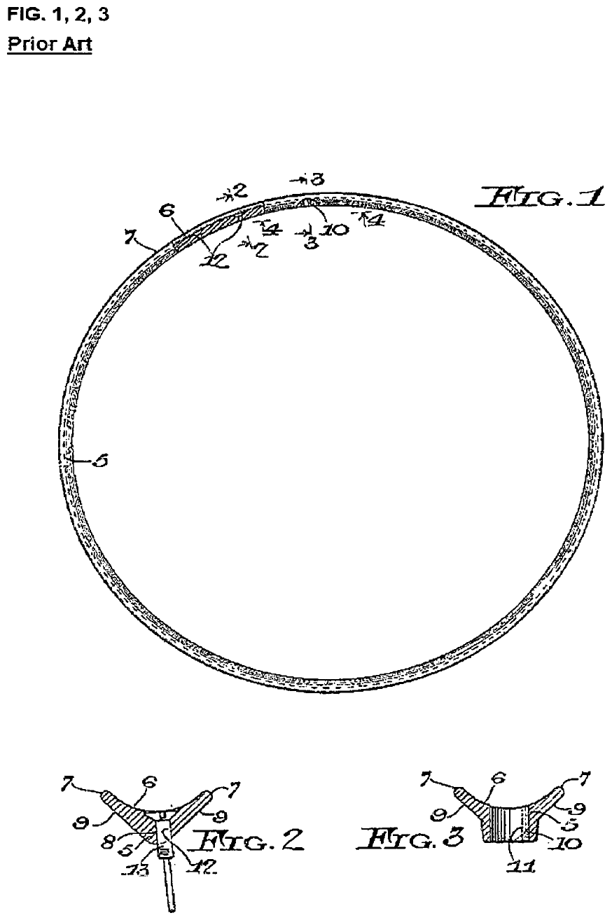

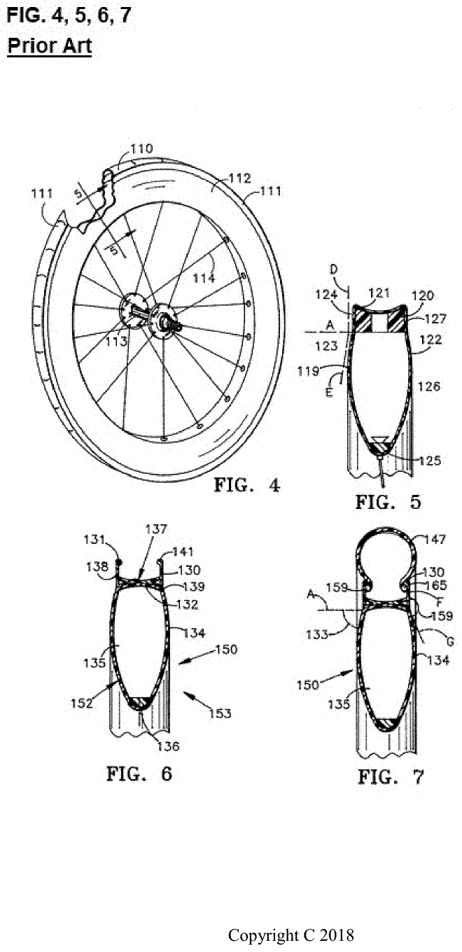

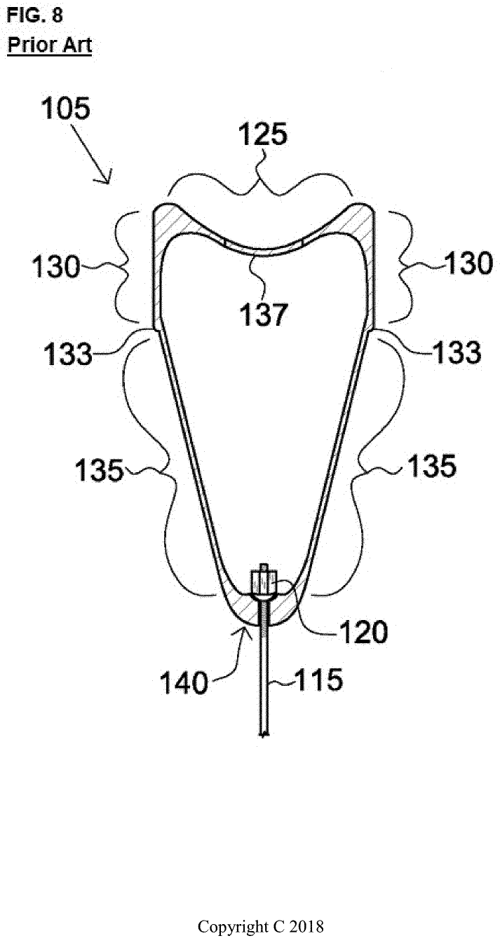

Prior art single-wall rim design is illustrated in FIGS. 1, 2, and 3 from a 1923 patent number U.S. Pat. No. 1,451,911. Single wall rim design with molded fiber material is currently used for molded fiber motorcycle wheel rims, and rarely for molded fiber bicycle rims. Prior art FIGS. 4, 5, 6, and 7 from a 1999 patent number U.S. Pat. No. 5,975,645 are an illustrative example of convex shaped walls of hollow bicycle wheel rim. And Prior art FIG. 8 from a 2012 patent number U.S. Pat. No. 8,313,155 is an illustrative example of straight shaped walls of hollow bicycle wheel rim profile. As more fully described in the Background section, physically to form a wheel rim, a formed tube of solid material is stiffer than a single wall rim, when each are the same circumference, width, weight, and material.

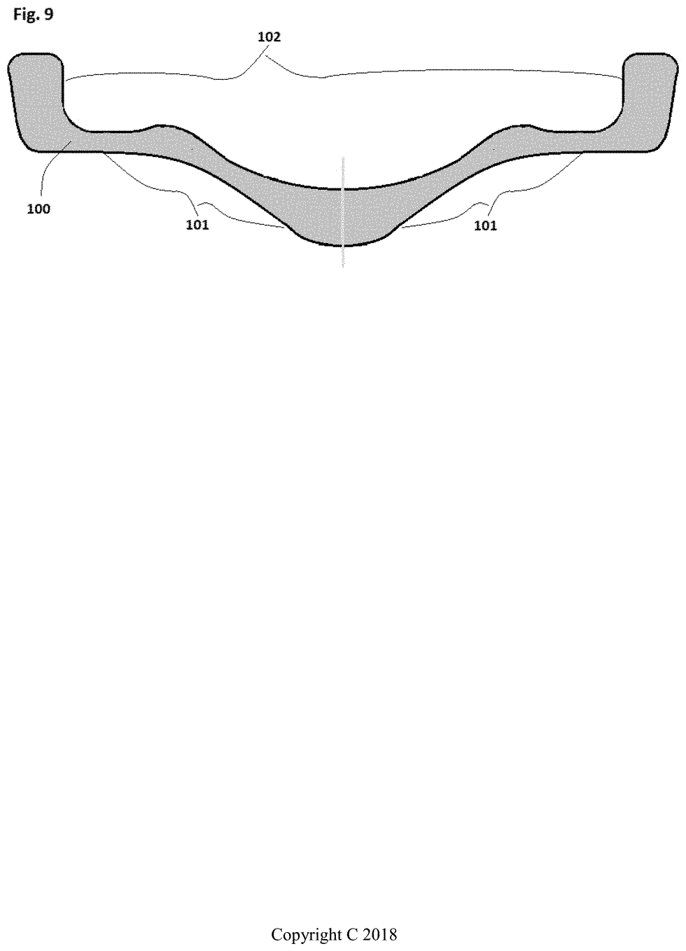

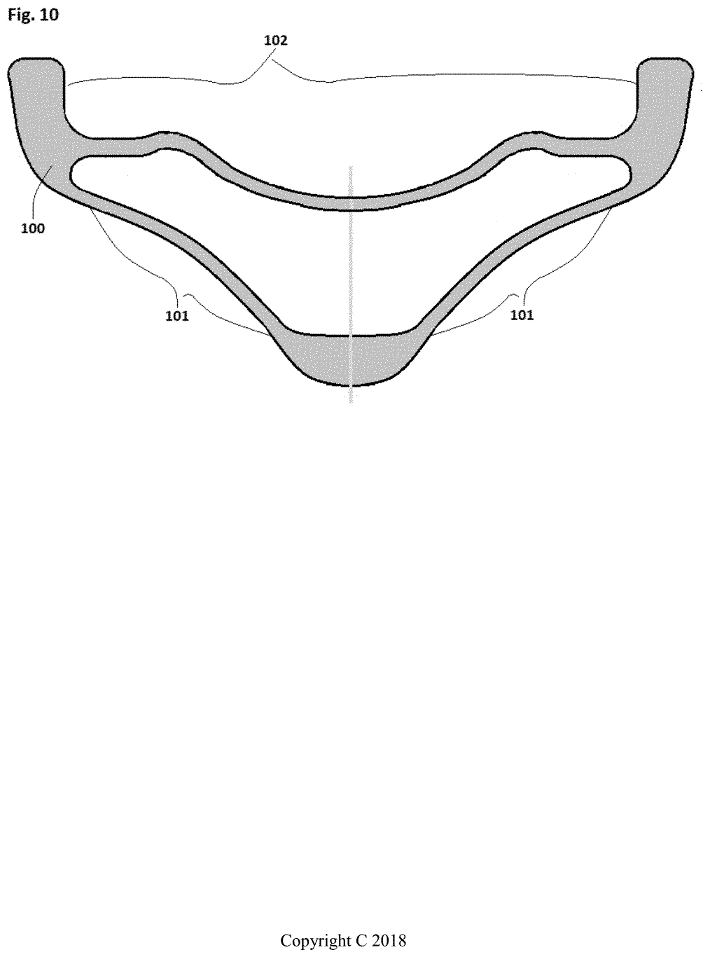

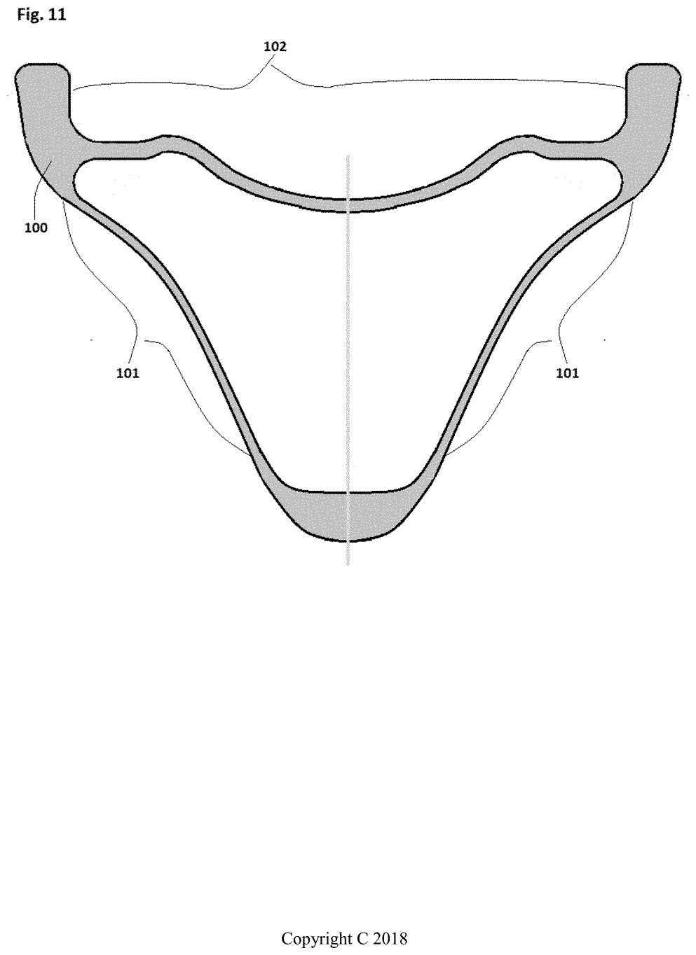

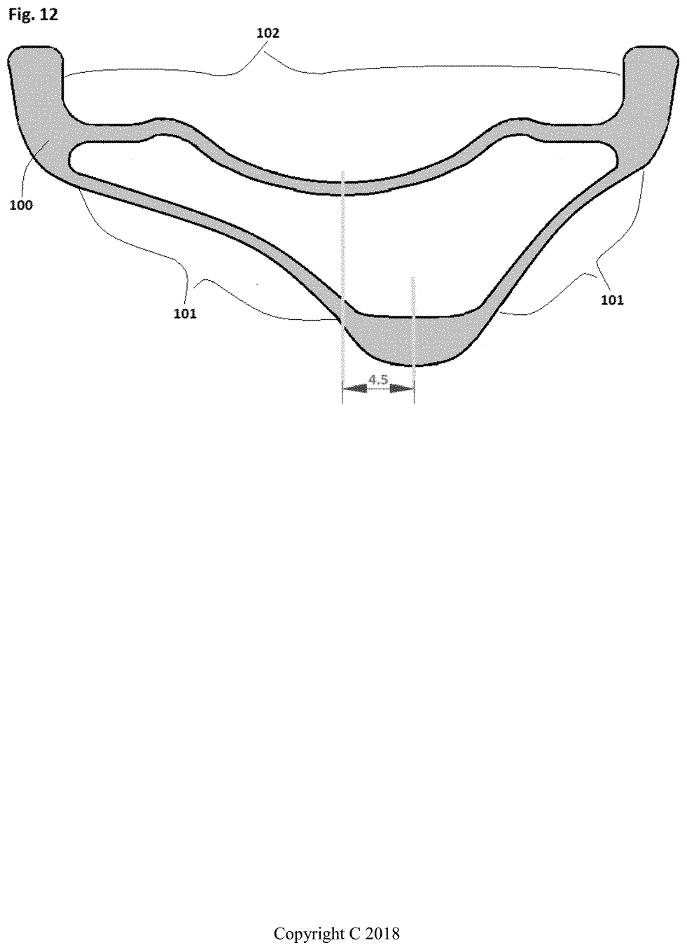

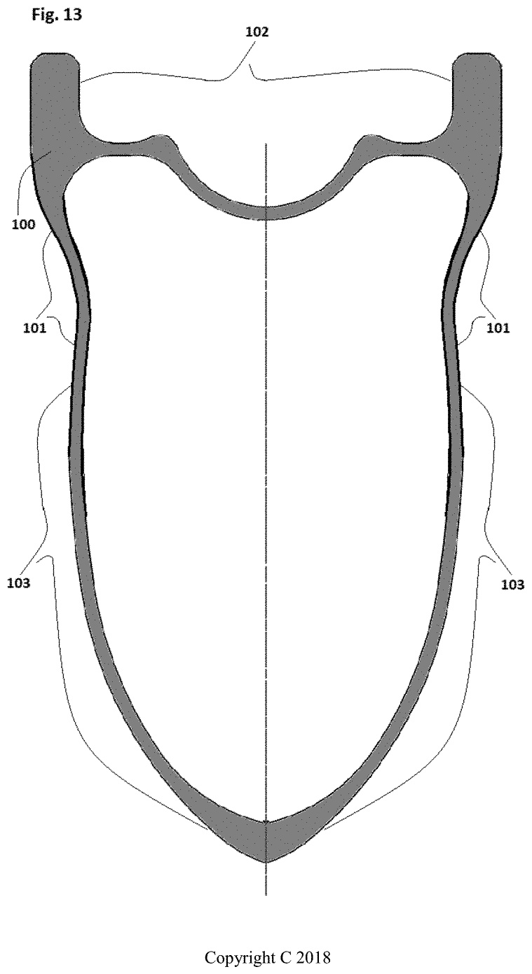

Turning now to FIG. 9 to FIG. 13, are illustrations of various sizes and shape examples. The invention is not limited to the illustrated shape examples. The molded fiber formed wheel rim 100 invention herein describes rim sidewalls designed with a fully outwardly-facing concave wall shape 101, and partially outwardly-facing concave wall shape transitioning to outwardly-facing straight wall or convex wall shape 103 when viewed in cross section profile. The crossing wall 102 in each of the the rims between the side walls have various profile contours to support and secure a tire.

The advantage of an outwardly-facing concave shaped molded fiber rim wall is the elimination or significant reduction of fiber extension when deformed vertically by radial loads, from carried weight loads and impact loads. All fibers or laminated layers of fibers of an outwardly-facing concave shaped molded fiber rim wall are compressed when deformed vertically by radial loads, from carried weight loads and impact loads. The compression of all fibers or laminated layers of fibers eliminates or significant reduces the problem of excessive extending fiber stretch to breakage, when a wheel rim is deformed by wheel radial loads, from carried weight loads and impact loads.

FIG. 1 to FIG. 13 illustrate various bicycle use wheel rims commonly utilizing spokes and nipples that connect a hollow rim to a wheel hub.

Rims for some bicycle wheels and for most heavier vehicles than bicycles can also be supported to the wheel hub by solid spoke arms attaching the rim to the hub, or continuous radial solid support of the rim to the hub, rather than tension spokes and nipples which are most common to bicycle wheels.

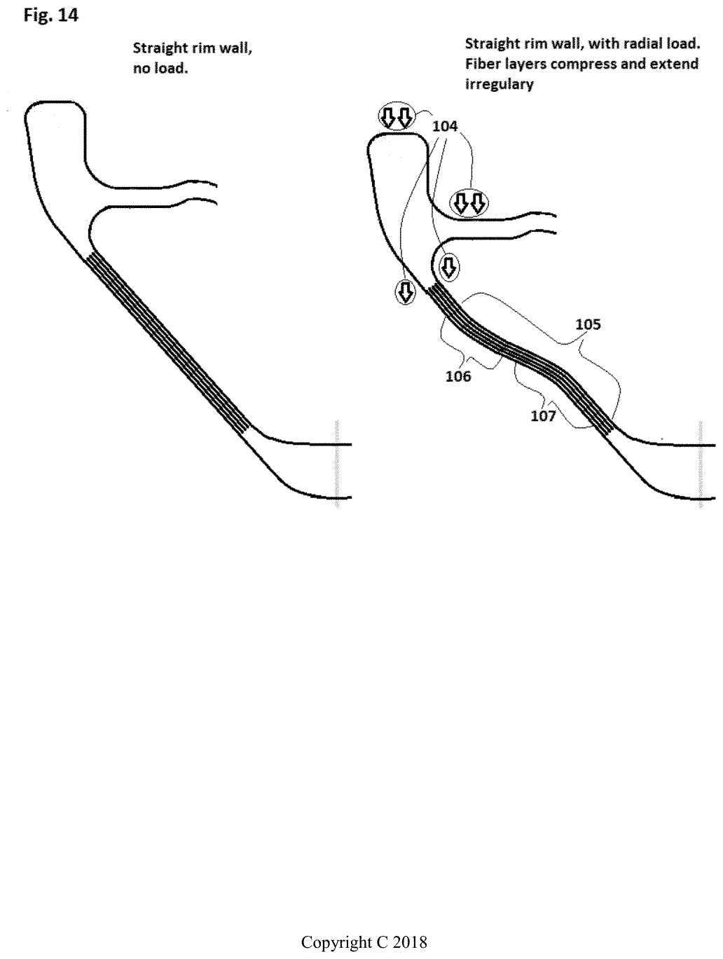

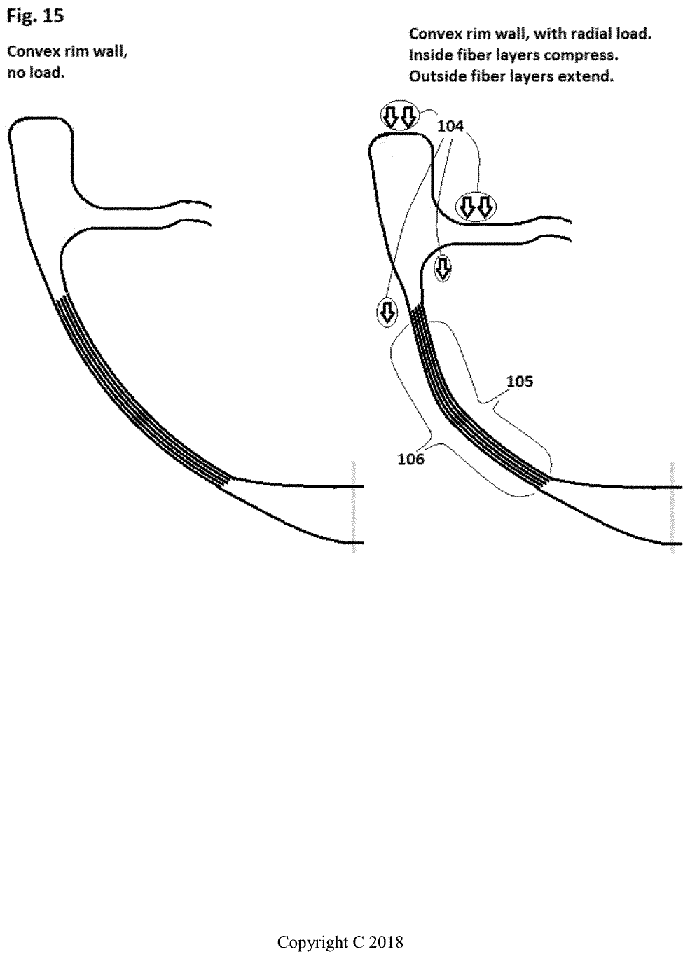

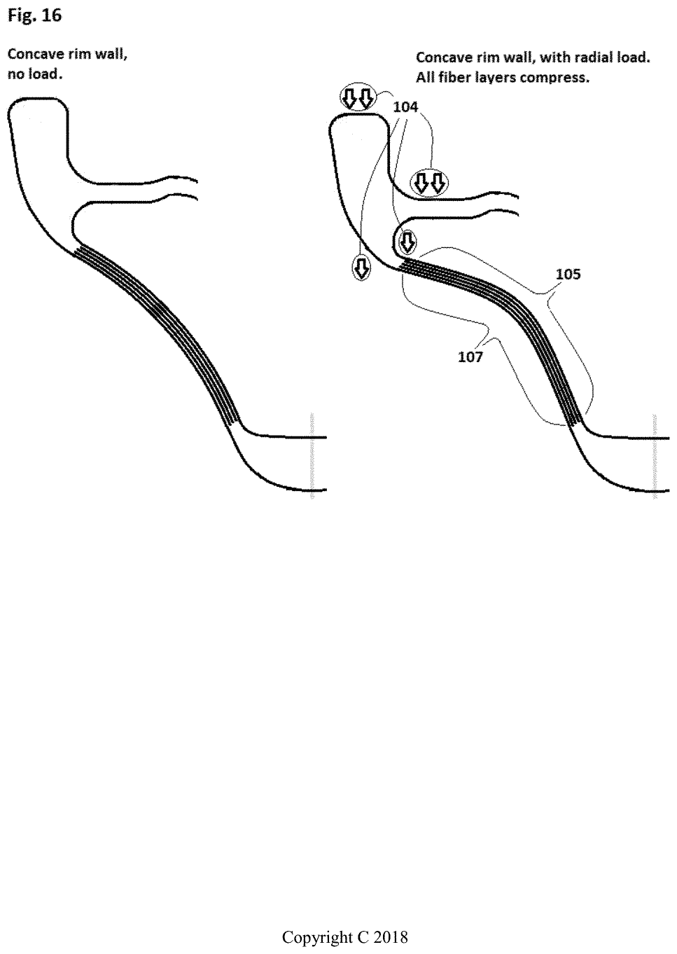

The increased rim durability by the invention described is best illustrated by comparing FIG. 14, FIG. 15, and FIG. 16 illustrations of layered molded fiber sidewalls.

Currently utilized molded fiber bicycle hollow rim design is illustrated in a straight-walled rim in FIG. 14 with no load and when a radial load 104 from rider weight, plus additional radial weight 104 from impact, or dynamic riding compression radial load 104. The flex of the straight wall resulting from compression radial load 104 produces inside fiber compression 105, but outside fibers have irregular extending fibers 106 when the wall becomes partially outward-facing convex flex, and compressing fibers 107 when the wall becomes partially outward-facing concave flexed by compression load 104. Partially extending fibers 106 are stretched to rapid failure.

Currently utilized molded fiber bicycle hollow rim design is illustrated in an outward-facing convex walled rim in FIG. 15 with no load and when a radial load 104 from rider weight, plus additional radial weight 104 from impact, or dynamic riding compression radial load 104. The flex of the outward-facing convex wall resulting from compression radial load 104 produces inside fiber compression 105, but outside fibers have extending fibers 106 when the wall is flexed by compression load 104. Extending fibers 106 are stretched to rapid failure.

The invention herein is described by a currently utilized molded fiber bicycle hollow rim design illustrated by FIG. 16 with no load and when a radial load 104 from rider weight, plus additional radial weight 104 from impact, or dynamic riding compression radial load 104. The flex of the outward-facing concave wall resulting from compression radial load 104 produces inside fiber compression 105, also the outside fibers have compressing fibers 107 when the wall is flexed by compression load 104. Compressing fibers 107 are not stretched to rapid failure.

| Citing Patent | Priority date | Applicant | Title |
|---|---|---|---|
| U.S. Pat. No. 446,189 | Dec. 24, 1889 | A. H. OVERMAN | Hollow wheel-rim |
| U.S. Pat. No. 758,190 | Sep. 8, 1903 | John F W Rethmeyer | Wheel-rim |
| U.S. Pat. No. 1,379,843 | Dec. 8, 1919 | Erastus Williams William | Hollow-rolled-rim wheel |
| U.S. Pat. No. 1,451,911A | Oct. 30, 1922 | Johnson Nels | Bicycle rim |
| U.S. Pat. No. 1,540,414 | Aug. 16, 1923 | Leon Montupet | Wheel for automobiles or other vehicles |
| U.S. Pat. No. 5,080,444 | Nov. 29, 1989 | E. I. Du Pont De Nemours And Company | Vehicle wheel |
| U.S. Pat. No. 5,975,645A | Sep. 9, 1996 | Leigh R. Sargent | Carbon bodied bicycle rim |
| U.S. Pat. No. 6,302,493B2 | Oct. 26, 1998 | Alvin R. Zemlicka | Lightweight motorcycle wheel |
| U.S. Pat. No. 8,313,155B2 | Sep. 15, 2008 | Jason Schiers | Advanced composite rim having molded in |
| | | | spoke holes |

1. A wheel rim formed with molded fiber utilizing rim walls including an outwardly-facing concave shape when viewed in cross section profile.

2. The rim of claim 1, can be formed comprising a hollow design, sometimes called a “double-wall” rim design.

3. The rim of claim 1, can be formed comprising having a singular rim wall, sometimes called a “single-wall” rim design.

4. The rim of claim 1, may utilize less than 100% of the rim wall face with an outwardly-facing concave shape when viewed in cross section profile, and the remaining percentage of rim wall may utilize any combination of outwardly-facing straight wall or convex shaped wall when viewed in cross section profile.
